(19) United States
(12) Patent Application Publication
(10) Pub. No.: US 2019/0003704 A1
(43) Pub. Date: Jan. 3, 2019

(54) Sustainable Oxygen Carriers for Chemical Looping Combustion with Oxygen Uncoupling and Methods for Their Manufacture

(71) Applicant: Institutt For Energiteknikk, Kjeller (NO)

(72) Inventors: Asunción Aranda, Oslo (NO); Anita Skulimowska, Brummundal (NO)

(21) Appl. No.: 16/065,195

(22) PCT Filed: Dec. 22, 2016
(86) PCT No.: PCT/NO2016/050267

§ 371 Date: Jun. 22, 2018

(30) Foreign Application Priority Data
Dec. 22, 2015 (NO) 20151775

(51) Int. Cl. F23C 10/00; C10J 3/72; B01J 23/889; B01J 37/03; B01J 8/26

(52) U.S. Cl. CPC F23C 10/005; C10J 3/725; B01J 23/8892; B01J 37/035; B01J 8/26; B01J 2523/847; B01J 2523/17; B01J 2523/72; B01J 2523/845; B01J 2523/842; F23C 2900/99008

(57) ABSTRACT

An oxygen carrier (OC) for use in Chemical Looping technology with Oxygen Uncoupling (CLOU) for the combustion of carbonaceous fuels, in which commercial grade metal oxides selected from the group consisting of Cu, Mn, and Co oxides and mixtures thereof constitute a primary oxygen carrier component. The oxygen carrier contains, at least, a secondary oxygen carrier component which is comprised by low-value industrial materials which already contain metal oxides selected from the group consisting of Cu, Mn, Co, Fe, Ni oxides or mixtures thereof. The secondary oxygen carrier component has a minimum oxygen carrying capacity of 1 g of O₂ per 100 g material in chemical looping reactions. Methods for the manufacture of the OC are also disclosed.

The present invention concerns an oxygen carrier for use in Chemical Looping technology with Oxygen Uncoupling (CLOU) as indicated by the preamble of claim 1. According to another aspect, the present invention relates to methods for the manufacture of such oxygen carrier as indicated by the preamble of claims 13 and 14.

### FIELD OF THE INVENTION

The present invention concerns highly active materials for carbonaceous fuels combustion with CO₂ capture by means of chemical looping combustion technology.

More specifically, the materials hereby presented are oxygen carriers with improved activity towards chemical looping combustion with oxygen uncoupling, with high mechanical and chemical stability, and are more environment-friendly and cost-effective than existing materials previously reported.

### BACKGROUND OF THE INVENTION

Conventional combustion of carbonaceous fuels involves the use of air at high temperature to provide the necessary oxygen for burning the carbon-rich fuel into carbon dioxide and steam. As a result, the combustion products are mixed with the remaining nitrogen coming from the air feed. Thus, the implementation of CO₂ capture to avoid Green House Gas emissions, by separation of CO₂ from nitrogen becomes very costly.

One of the most promising technologies for cost-effective CO₂ capture in carbonaceous fuels combustion for energy generation is the Chemical Looping Combustion technology (CLC). In this technology, the necessary oxygen for the combustion is supplied by a solid which contains metal oxides (i.e. oxygen carrier or OC). With this technology, the nitrogen is eliminated from the process, thus reducing the NOₓ emissions and producing a flue gas stream consisting only of CO₂ and H₂O.

In CLC technologies the oxygen carrier is transported in between two reactors: the combustion or fuel reactor and the air reactor. In the fuel reactor, the oxygen carrier provides the oxygen for combustion whilst being reduced. In the air-operated reactor (air reactor), the oxygen carrier is exposed to air at high temperature to re-oxidize before being sent back to the fuel reactor (FIG. 1). As a result, the carbonaceous fuel is burnt in an oxygen-rich atmosphere without nitrogen, whilst CO₂ can be easily separated from steam and can be further processed for utilization or storage.

The generic equations for CLC process are as follows:

(2n+m)MₓO_{y}+CₙH₂ₘ→(2n+m)MₓO_{y-1}+mH₂O+nCO₂ Eq.1

In the regeneration step, the reduced oxygen carrier is re-oxidized with air according to:

2MeₓO_{y-1}+O₂→2MeₓO_{y} Eq.2

The overall heat released in reactions 1 and 2 is equal to the value that would be obtained if the same fuel were combusted directly in air. Thus, if the oxygen carrier has the correct chemical composition—and the physical and mechanical properties—it can transport oxygen efficiently from the air reactor to the fuel reactor along a certain number of cycles, before it is extracted from the system. The end-life of the oxygen carrier occurs either in the cyclones (due to attrition and erosion effects), in a purge stream extracted from the system to maintain efficiency in the process (when the OC loses its oxygen capacity and requires partial substitution) or mixed in the ashes purge (in the case of solid fuels combustion). Therefore, OCs with suitable chemical and mechanical stability to bear the process conditions without breakage and/or deactivation can reduce the operation cost of the CLC plant.

Whilst numerous studies have been carried out to improve those properties in OCs for gaseous fuels, the combustion of solid fuels by CLC is still at an early stage of development. In practice, the combustion of solid fuels by CLC has low efficiency and/or high cost when applying OCs that have been developed for gaseous fuels, mainly due to very slow reaction rates of the fuel with the lattice oxygen of the OC, in a solid-solid reaction. To overcome this limitation, alternative modifications of the CLC process have been proposed and are under study.

A first alternative is the prior gasification of the solid fuel in oxygen or in a mixture of oxygen and steam. Then, the gasification products can be sent to a conventional CLC for gaseous fuels. The main disadvantage of this approach is the requirement of an air-separation unit to gasify the solid fuel with oxygen in a nitrogen-free atmosphere, which substantially increases the CO₂ capture costs.

A more efficient alternative is the in-situ gasification of the solid fuel in the fuel reactor, the so-called in-situ gasification chemical looping combustion or iG-CLC. In the iG-CLC, the fuel is physically mixed with the oxygen carrier in the fuel reactor and gasified using H₂O and/or CO₂. In this case, the conversion of the solid fuel is still limited by the relatively slow gasification reaction, reducing the efficiency of the process. Other major disadvantages of iG-CLC technology that impede its industrial implementation concern the necessity of recycling unconverted fuel, or the need of including an intermediate process step (a re-burner), where the unburnt solid fuel from the fuel reactor can be totally combusted. Additionally, to improve the efficiency of the iG-CLC, high OC to fuel ratios are required, which also adds investment (e.g. bigger equipment) and operation costs (e.g. more oxygen carrier per fuel mass, higher make-up flows, etc.).

In general, the above mentioned technological solutions increase the complexity of the CLC system, and add Capex and Opex to the process. Therefore, the desirable solution lays on more reactive oxygen carriers or different reaction mechanisms to achieve complete combustion of the solid fuels in a conventional CLC configuration, with no additional equipment and limited or no increase of the OC solid inventory above stoichiometric needs.

Lewis et al. [1] presented for the first time the application of a specific chemical reaction for solid fuels gasification: the decomposition reaction of a solid oxygen carrier that releases molecular oxygen at high temperature. In 2009, Mattisson et al. [2] adapted this concept to solid fuels combustion in the field of Chemical Looping, and introduced the acronym CLOU (Chemical Looping with Oxygen Uncoupling).

The first reaction step of the CLOU process is the release of molecular oxygen from the thermal decomposition of the oxygen carrier:

2MexOy→2MeₓO_{y-1}+O₂(g) Eq.3

Subsequently, the solid fuel reacts with oxygen to produce, after the condensation of H₂O, a pure stream of CO₂ according to:

CₙH₂ₘ+(n+m/2)O₂(g)→nCO₂(g)+mH₂O(g) Eq.4

To close the cycle, the oxygen carrier is re-oxidized in air according to Equation 2.

Simultaneously, solid fuels are partially gasified with the steam and CO₂ coming from both the fluidization agent and/or from reactions 3 and 4. The gasification products (i.e. light hydrocarbons) can react with both the molecular oxygen from reaction 3 and/or directly with the remaining lattice oxygen of the OC. In case of combustion of solid fuels, the solid fraction can react directly with the molecular oxygen released from reaction 3, much faster than by solid-solid reaction with lattice oxygen, as illustrated in FIG. 2.

Thus, the main difference between conventional CLC and CLOU is the mechanism by which the fuel is oxidized. In CLOU, gaseous and solid fuels react not only with the molecular oxygen released by the oxygen carriers (gas-gas and solid-gas reactions), but also the gas fraction reacts with the lattice oxygen of the oxygen carrier as it does in the conventional CLC gas-solid reaction. Thus, in CLOU, since the gasification reactions are partially replaced by a much faster combustion process, fuel conversion can occur more efficiently for the same time and OC/fuel ratios, compared to conventional CLC.

Oxygen carrier materials for CLOU need to fulfill basically the same requirements as standard OC for CLC, except that they have to provide molecular or gaseous oxygen in addition. Desirable features of OCs for CLOU are [2, 3]:
High oxygen transfer capability, with favorable thermodynamics regarding the full conversion of fuel to CO₂.
High reactivity in reduction and oxidation reactions.
High chemical stability, maintained during many successive redox cycles without deactivation.
High mechanical stability at combustion temperatures, to minimize losses of elutriated solids due to attrition.
Good fluidization properties and absence of agglomeration.
Low cost.
Low environmental impact.
Moreover, OCs for CLOU have to be able to release molecular oxygen under specific process operating conditions. As a consequence, CLOU significantly narrows the possible choice of materials compared to conventional CLC.

Three metal oxide systems have been identified to be the most suitable alternatives for the CLOU process, showing the specific property of releasing molecular oxygen into the gas phase under adequate process conditions: CuO/Cu₂O, Mn₂O₃/Mn₃O₄, and Co₃O₄/CoO [2].

Among those options, an important selection criterion for OCs appropriate for CLC is the total oxygen carrying capacity, which represents the maximum amount of oxygen that can be provided by the OC for the combustion reaction per total mass of solid. More specifically, for CLOU systems the oxygen has to be released as molecular oxygen. For example, the system CuO—Cu₂O has an oxygen carrying capacity of 10 g O₂/100 g CuO whereas Co₃O₄—CoO and Mn₂O₃—Mn₃O₄ have lower oxygen carrying capacities (6.6 g O₂/100 g Co₃O₄ and 3.4 g O₂/100 g Mn₂O₃, respectively) [5].

Unfortunately, the use of any of Cu, Mn or Co for CLOU, or Fe or Ni for CLC technology as pure metal oxides is not feasible, due to a variety of limitations, including: low melting temperature (which would cause melting, sintering, clogging of the system and deactivation of the material), mechanical weakness (which causes fracture by attrition, erosion and loss of fines in the cyclones that has to be replaced as make-up flow), etc.

Therefore, most of the research efforts on CLC and recently in the CLOU technology have been oriented towards the stabilization of those metal oxides by synthetic supports. In the literature it can be found a large collection of publications related to supported-oxygen carrier's production and testing [3, 6, 7].

Promising results have been achieved by combining CuO with certain synthetic stabilizers or supports. Depending on the final application of the OC (commonly combustion of gaseous or solid fuels), different authors focused respectively on total oxygen carrying capacity (OCs for CLC of gas fuels) or the molecular oxygen release capacity (e.g. OCs suitable for CLOU of solid fuels). Gayan et al. [7] prepared different OCs containing from 15 to 80 wt. % CuO on synthetic supports in order to investigate their CLOU properties. Those materials reached the theoretical values of oxygen release capacity for their corresponding composition, i.e. 4, 6 and 8 (g O₂/100 g OC) for samples containing 40, 60 and 80 wt. % of CuO, respectively. The crushing strength of those materials varied from 2.3 N to 4.0 N for samples containing 40 wt. % of CuO; from <0.5 to 3.0 N for 60 wt. % of CuO and from 0.8 to 2.6 N for 80 wt. % of CuO; depending on the support type and preparation method. Additionally, Imtiaz et al. [6] reported that the use of spinel materials (such as MgAl₂O₄-stabilized OC) increases significantly the stability of oxygen release capacity during cycling for high content of CuO, compared to CuO supported over Al₂O₃.

However, using those synthetic supports does not increase the O₂ capacity of an OC above the maximum theoretical capacity corresponding to the active phase, i.e. the O₂ capacity corresponding to the total active metal oxide over the synthetic support. Regarding total oxygen carrying capacity of supported OCs, the maximum values reported in publications is 8.3 and 8.7 for 41 wt. % CuO supported on SiO₂ and 43 wt. % CuO supported on MgAl₂O₄ [8].

Nevertheless, most of the OCs are either specific to gaseous fuels (for which the CLC technology has been initially developed), have limited oxygen carrying capacity (since the stabilizing support decreases the activity per total mass), show limited oxidation reactivity (due to deactivation over cycles), have low resistance to attrition and/or a have high economic and environmental cost.

Only in the late years the CLC technology has started to be developed for solid fuels combustion and it can be found few publications focused on this specific application by introducing the CLOU effect. In CLOU for solid fuels, the oxygen carrier cost has even a larger impact on the economic feasibility of the process: solid fuels combustion by CLOU requires purging from the reactors the fuel ashes (e.g. from coal or biomass), which may drain out of the process part of the oxygen carrier, generating big amounts of solid waste. The OC extracted has to be replaced, which adds operation cost to the technology. Thus, cost-efficient and low-environmental-impact oxygen carriers are key aspects for the CLOU technology for solid fuels to be economically and environmentally feasible. The OCs developed up to now for solids fuels are not applicable at industrial scale due to low efficiency (e.g. when using natural ores) and/or high production cost (complex synthesis methods, use of exotic compounds, etc.).

Imtiaz et al. [5] thoroughly reviewed the state of the art of OCs for chemical looping with oxygen uncoupling, in terms of thermodynamics, materials development and synthesis methods. At present, OCs containing copper, manganese, iron, nickel and/or cobalt are synthesized supported over varied stabilizing materials (alumina (Al₂O₃), zirconia (ZrO₂), magnesium aluminate (MgAl₂O₃), silica (SiO₂), etc.), or are directly synthesized as perovskite-type oxides.

These oxygen carriers show the following limitations in efficiency and cost:
The maximum loading of active phase—over a stabilizing support—that stays stable along cycles is limited for most of the cases, due to sintering and deactivation effects over cycles.
The production methods and/or compounds conforming the stabilizing phase may be costly at industrial scale. The support adds production, transport and waste handling costs.

To reduce the production and operation cost of CLC for solid fuels some authors have tested natural ores that contain a certain amount of suitable metal oxides. Linderholm et al. [9] tested ilmenite (Fe-containing natural ore) for coal combustion in a 10 kW CLC plant. Arjmand et al. [10] tested different manganese ores and compared them with the performance of ilmenite. From those results, it can be concluded that the utilization of natural ores could initially contribute to decrease the expected cost of the CLC technology, but the activity of these materials is very low, and this key aspect would have overall economic drawbacks due to considerably lower efficiency than synthetic oxygen carriers.

In summary, there is a need for more efficient oxygen carriers—especially for solid fuels combustion—and a need in the materials producing industry to develop added-value products for CO₂ capture in an increasingly competitive materials market.

Thus, the present invention provides a solution to produce cost-effective oxygen carriers, suitable for solid, liquid or gaseous fuels combustion by CLOU, with added sustainability and efficiency compared to existing materials.

### OBJECTIVE OF THE INVENTION

It is an objective of the present invention to provide environmentally and economically sustainable oxygen carriers, for an effective combustion of carbonaceous fuels (solid, liquid, gaseous or mixtures thereof) by Chemical Looping with Oxygen Uncoupling technology (CLOU).

It is in particular an objective to provide such oxygen carriers which are effective for CLOU with predominantly solid carbonaceous fuels.

It is also an objective of the present invention to provide synthesis methods for producing the above mentioned oxygen carriers, by simple, scalable and cost-effective methods.

### BRIEF SUMMARY OF THE INVENTION

The above objectives are fulfilled by the present invention which according to a first aspect concerns an oxygen carrier (OC) for use in Chemical Looping technology with Oxygen Uncoupling (CLOU) as defined by claim 1.

According to a second aspect, the present invention concerns methods for the manufacture of an oxygen carrier according to the first aspect of the invention, as defined by claims 13 and 14.

Preferred embodiments of the invention are disclosed by the dependent claims.

Generally, the present invention may be seen as providing an oxygen carrier for CLC where the activity of a commercial grade oxygen carrier, represented by the primary oxygen carrier component, is enhanced or stabilized to improve its chemical and/or mechanical properties by combining it with an active support, represented by the secondary oxygen carrier component.

In an alternative perspective, the present invention provides an oxygen carrier produced by enrichment with added copper, manganese, cobalt oxides or mixtures thereof of low-value industrial materials (process streams, industrial wastes or mixtures thereof) that are already active towards carbonaceous fuels combustion by Chemical Looping technology (CLC).

Thus, the present invention provides an oxygen carrier for Chemical Looping Technology with Oxygen Uncoupling (CLOU) based on low-value industrial process materials and waste, showing improved reactivity, long-term stability, cost-efficiency and added environmental benefits, compared to previously existing synthetic and natural oxygen carriers.

One of the unique features of the present invention is that the chemical and mechanical stabilization of copper, manganese, cobalt oxides or mixtures thereof by combination with already-active and low-value materials as support provides more environmentally friendly OCs and increases the maximum total oxygen carrying capacity of the OC, compared to the use of inert supports to stabilize copper, manganese, cobalt oxides or mixtures thereof as the only active phase in previously reported OCs.

In the present invention, the support already contains metal oxides active in chemical looping combustion (e.g. Mn, Fe, Co, Ni, Cu oxides or mixtures thereof) which adds total active phase for the reaction without increasing the sintering and deactivation effects that may appear when loading inert supports with equivalent amounts of active copper, manganese, cobalt oxides or mixtures thereof.

On the other hand, the combination of an already active material with added copper, manganese, cobalt oxides or mixtures thereof overcomes the very low reactivity showed by natural ores previously tested for the chemical looping technology, due to the low content per weight of active phase normally present in natural ores.

Additionally, there are various industries that generate process streams, low added-value products or waste that are suitable for constituting a secondary oxygen carrier component according to the present invention (e.g. in titanium production from ilmenite or in manganese oxide production from manganese ores). These industrial actors will benefit of the innovative application of those low-value materials transformed by the present invention into added-value materials for an efficient technology for combustion of carbonaceous fuels with integrated CO₂ capture.

Concretely, the secondary oxygen carrier component may be provided, in whole or in part, from industrial processes for production of ilmenite concentrate, containing iron oxides; processes involving manganese-bearing materials, hereunder manganese oxides; processes involving cobalt-bearing materials, hereunder cobalt oxides; and processes involving nickel-bearing materials, hereunder nickel oxides. It is worth noticing that these oxides are compatible and can be included in any combination in the secondary oxygen carrier component.

Thus, this invention solves simultaneously the following technology and economic gaps for obtaining sustainable and cost-effective oxygen carriers:
Increases of the oxygen carrying capacity beyond the limits of the maximum content of copper, manganese, cobalt oxides or mixtures thereof that can be stabilized over stabilizing supports, without sintering or deactivation problems over cycles.
Represents an advancement from state of the art materials especially on solid fuels combustion, by providing highly active OCs with CLOU effect, suited for carbonaceous fuels (solid, liquid, gaseous or mixtures thereof).
Produces chemically and mechanically stable oxygen carriers, which diminishes operation costs due to deactivation, attrition and/or erosion of the materials.
Utilizes low-value industrial materials and waste as stabilizing support, which contributes to more sustainable industry, and decreases the expected operating costs of the chemical looping technology, especially for the case of solid fuels combustion.
Applies simple, scalable and cost-effective synthesis methods for the production of highly active OCs.

### DETAILED DESCRIPTION OF THE INVENTION

The following description is provided to enable any person skilled in the art to use the invention, and sets forth the best mode considered by the inventors for applying the invention for the above mentioned objectives.

The innovative principles of the present invention are defined herein specifically to provide an oxygen carrier based on industrial process materials and waste, showing improved reactivity, improved mechanical properties, improved cost-efficiency and added environmental benefits compared to previously reported synthetic and natural oxygen carriers.

The disclosure provides an oxygen carrier comprised of a low-value industrial material (intermediate stream, by product or waste) with certain activity in Chemical Looping process to which copper, manganese, cobalt oxides or mixtures thereof are added by means of different synthesis methods.

The term “oxygen carrier” or “OC” is used to indicate a material comprising at least two components: a primary oxygen carrier component composed of copper, manganese, cobalt oxides or mixtures thereof and a secondary oxygen carrier component containing copper, iron, manganese, cobalt, nickel oxides or mixtures thereof, herein also referred to as an active support wherein the function of these metals and their respective oxides is to form an active site for oxidation and reduction reactions as given in the reactions 1-2 and/or reactions 2-4. It is also the function of the secondary oxygen carrier component to serve as support to the first oxygen carrier component and improve the chemical and mechanical stability of the Cu, Mn, Co oxides.

The term “carbonaceous fuel” is used to indicate any material containing inorganic or organic bound carbon, such as, but not limited to, coal, biomass, syngas, natural gas, or pyrolysis gases and/or mixtures of those. Inorganic bound carbon indicates any carbon in an inorganic molecule such as in, but not limited to, carbon monoxide, cyanide or graphite. Organic bound carbon indicates any carbon in an organic molecule such as in, but not limited to, alkanes, alkenes, alkynes and/or aromatic hydrocarbons and/or hydrocarbons containing hetero-atoms. The physical state of the carbonaceous fuel can be in form of solid, liquid, gaseous or mixtures of those.

The term “chemical-looping process” or “chemical-looping process cycle” or “CLC” indicates any chemical-looping processes, such as, but not limited to combustion processes and gasification (i.e. partial oxidation) where the oxygen carrier is circulated between two reactors. In a first reactor (“air reactor”), the OC is fully oxidized (i.e. the metals above mentioned are converted into their respective oxides and/or mixtures thereof) by direct contact with air at a temperature above 700° C. In the second reactor (or “fuel reactor”), the OC is contacted with carbonaceous fuel and reacts forming gaseous products (i.e. gasification and combustion products), such as, but not limited to, CO₂ and H₂O. The OC is then transported back to the air reactor, re-oxidized and transported again to the fuel reactor for a new cycle.

The term “chemical-looping process with oxygen uncoupling” or “CLOU” means any chemical-looping processes, such as, but not limited to combustion processes and gasification (i.e. partial oxidation) where the oxygen carrier is circulated between two reactors as above defined for the conventional CLC, with the singularity that: the oxygen carrier contains a certain amount of metal oxides that can evolve molecular oxygen to the gaseous phase during the combustion and/or gasification process taking place in the fuel reactor.

The term “reducing” or “reduction” referred to a metal oxide particle means the loss of oxygen from the metal oxide particle resulting in the formation of a reduced metal oxide particle. Thus, a CLC or a CLOU “cycle” means in this context each consecutive oxidation and reduction steps-pair of the OC circulating from the air reactor to the fuel reactor.

The term “total oxygen carrying capacity” or “oxygen transport capacity” or “CLC-CLOU behavior” or “CLC-CLOU activity” indicates total amount of oxygen transported by an OC circulating between two reactors during CLC-CLOU process. It includes both molecular oxygen released from OC and reacting with the fuel particles, as given in the reactions eq. 2-4 as well as lattice oxygen of OC which is transported with an OC to fuel reactor and reacts as given in the reactions eq. 1-2. The term “ore” or “natural ore” is a mineral, a rock, or a native metal that serves as source of metals or non-metallic substances and that can be mined and processed at a profit.

The term “commercial grade metal oxides” is used to indicate the grade or quality level of metal oxides typically used for CLC materials in the recent prior art or commercially available at present as metal oxides, irrespective of any combination of such oxides with synthetic supports and despite the concentration of the majoritarian oxide or its corresponding metal salt.

More specifically, the primary oxygen carrier component preferably has a minimum oxygen carrying capacity of 1.6 g O₂ per 100 g of primary oxygen carrier component. More preferred is an oxygen carrying capacity higher than 2.5, even more preferred higher than 5 and most preferred higher than 9 g O₂/100 g of primary oxygen carrier component.

The term “overburden” is the waste rock or other material that overlies the ore or mineral body of interest, and is displaced during mining without being processed.

The term “tailings” refer to the materials left over after the process of separating the valuable fraction from the worthless or uneconomic fraction of an ore, and so has no longer industrial application. They are also known as mine dumps, tailings, waste or refuse fraction. The composition of tailings is directly dependent on the composition of the ore and the process of mineral extraction used on the ore. The amount of tailings is also dependent on the specific ore type and the extraction or refining process used, and it can be as large as 90-98 wt. % for some copper ores.

The term “industrial streams” or “industrial materials” refer to any material that is the result of physical and/or chemical modification after mining of a natural material, with the purpose of producing a valuable product at a profit, including, but not limited to, crushing, grinding, gravity separation, magnetic separation, flotation separation, chemical leaching or thermal processing. Therefore, in the present invention, “industrial streams” or “industrial materials” include any material selected from the group consisting of overburden, tailings, intermediate process materials, by-products, waste or combinations thereof that are the result of an industrial activity that modifies metal oxides-bearing materials for a commercial purpose.

In the present invention, “secondary oxygen carrier component” or “active support” refers to any low-value industrial material that contains a minimum of 1 wt. % of a metal oxide active in chemical looping reactions, selected from the group consisting of copper, manganese, cobalt, iron and nickel oxides, or combinations of those, and is object to be combined or enriched with additional metal oxide selected from the group consisting of copper, manganese and cobalt oxides, or combinations of those.

The term “enrichment” is used to indicate the addition of specific compounds (in this invention copper, manganese, cobalt oxides or mixtures thereof) to existing materials coming from industry that already have chemical activity towards chemical looping reactions for carbonaceous fuels combustion (i.e. an active support), with the object to produce and OC with increased total oxygen carrying capacity per weight compared to the low value industrial material.

In a preferred embodiment, the present invention provides an oxygen carrier comprising preferably from 15 wt. % to 99 wt. % of primary oxygen carrier component, the remaining material comprising at least a secondary oxygen carrier component (the active support). In a more preferred embodiment, the present invention provides an oxygen carrier comprising 40 to 90 wt. % of primary oxygen carrier component and a ratio between the amount of secondary oxygen carrier and the amount of primary oxygen carrier of at least 1:9. In another preferred embodiment, the present invention provides an oxygen carrier comprising 60 to 80 wt. % of primary oxygen carrier component and a ratio between the amount of secondary oxygen carrier and the amount of primary oxygen carrier of at least 1:4.

In a preferred embodiment the primary oxygen carrier is predominantly comprised by oxides of Cu.

In another preferred embodiment, the present invention provides an oxygen carrier, wherein said active support or secondary oxygen carrier component is a low-value industrial material containing metal oxides selected from the group consisting of Cu, Mn, Co, Fe and Ni oxides or mixtures thereof and showing oxygen carrying capacity of at least 1.2 g of O₂/100 g of this material, more preferred showing an oxygen carrying capacity of at least 1.5 g O₂/100 g material, even more preferred at least 2 g O₂/100 g material and most preferred an oxygen carrying capacity of at least 3 g O₂/100 g material. Typical oxygen carrying capacities for the secondary oxygen carrier are in the range from 1.5 to 4.5 g O₂ per 100 g of the secondary oxygen carrier.

An oxygen carrier as described in the present invention shows high mechanical and chemical stability over cycles in a chemical combustion oxidation process, allowing said OC eventually to be used for more than 10 cycles, more preferably to be used more than 100 cycles, even more preferably more than 1000 cycles in CLOU process.

Furthermore, said oxygen carrier can be eventually recovered from the reactor system and be re-activated (e.g. by enriching again with Cu, Mn, Co oxide or mixtures thereof) and recycled back to the system for further use.

In a preferred embodiment, the present invention provides an oxygen carrier, wherein the oxygen carrying capacity, which is expressed in grams of oxygen provided for the CLC reactions per grams of total oxygen carrier in its oxidized form, of said OC is higher than 1.2 g O₂/100 g OC. In a more preferred embodiment, the present invention provides an oxygen carrier, wherein the oxygen carrying capacity of said OC is higher than 6 g O₂/100 g OC. In a most preferred embodiment, the present invention provides an oxygen carrier, wherein the oxygen carrying capacity of said OC is higher than 12 g O₂/100 g OC.

The term “crushing strength” is used to indicate the greatest compressive load that a material can withstand without fracturing and it is determined by ASTM B-438 and B-439 standards. Crushing strength can be measured using, e.g., a handheld Digital Force Gauge SHIMPO FGV-10X test bench and it is expressed in Newton, N.

The term “attrition” refers to the phenomenon of physical wear that is the result of erosion, friction, and/or temperature and/or pressure effects causing the material degradation or loss of mechanical properties. Attrition is generally measured using the “Air Jet method” (ASTM5757), and it is expressed as the fraction of material loss in weight percentage over a certain time.

In a preferred embodiment, the present invention provides an oxygen carrier, wherein the crushing strength, of said particles is higher than 3 N. In a more preferred embodiment, the present invention provides an oxygen carrier, wherein the crushing strength of said particles is higher than 5 N. In a most preferred embodiment, the present invention provides an oxygen carrier, wherein the crushing strength of said particles is higher than 7 N. Including certain amounts of ashes from fuel combustion in the OC may facilitate the production process and enhance the mechanical stability of the product and represents a preferred embodiment of the invention. A preferred way of doing this is to mix fuel ashes with the secondary oxygen carrier component before the latter is combined with the primary oxygen carrier component.

The amounts of components other than the primary and the secondary oxygen carrier components in the OC, if at all present, such as ashes and/or other binders, is typically less than 50 wt. % of the OC, more preferably less than 40 wt. % of the OC, and even more preferably less than 30 wt. % of the OC. Typical amounts of ashes and/or other binders are in the range 0-30 wt. % of the OC.

The OC materials of the present invention can be agglomerated, compacted or precipitated to reach the desired particle size and mechanical properties by means of state of the art methods, including, but not limited to, precipitation, compaction, pelletization, and spray drying.

The combustion or gasification of carbonaceous fuels (solid, liquid, gaseous or mixtures thereof) largely benefit of the high activity of the OC materials disclosed in the present invention, especially for the case of solid fuels, where the state of the art OCs show either low oxygen capacity, high preparation cost, short lifetime, or are not easily scalable for industrial implementation, among other limitations.

The utilization of low-value industrial materials (process streams and/or waste) as OC support has not ever been reported before. Furthermore, none of the previous attempts ever presented materials where the active phase is supported over a reactive material, which also has activity as oxygen carrier and its origin in waste or industrial streams. On the other hand, the production of certain industrial products (e.g. the production of titanium from ilmenite, copper and manganese materials from natural ores) generate large amounts of solid waste. Among those process streams and final wastes, some of these materials contain certain amount of active metals suitable for the CLOU technology, though, at present, there have not been further developed for such application. Therefore, the present invention brings synergetic benefits to other industries than energy generation industry, by producing OCs with added-value due to the utilization of waste or low-value industrial streams as support.

### BRIEF DESCRIPTION OF THE FIGURES AND TABLES

FIG. 1 illustrates the schematic system of chemical looping process.

FIG. 2 illustrates generic interaction types between solid fuels and oxygen carrier occurring in fuel reactor of iG-CLC and CLOU technologies modes.

FIG. 3 illustrates evolution of O₂ carrying capacity over CLC cycles.

FIG. 4 illustrates the evolution of gaseous O₂ uptake/release capacity over CLOU cycles.

FIG. 5 illustrates long-term stability of O₂ capacity over cycles; 42 redox cycles for CLOU and 90 redox cycles for CLC-CLOU.

FIG. 6 illustrates attrition resistance of up-scaled OC corresponding to Example 6 determined after 5 h and 24 h at room temperature and after 5 h at 800° C.

FIG. 7 illustrates interaction of OC with solid fuel at 925° C.; A-coal, B-biomass (wood chips).

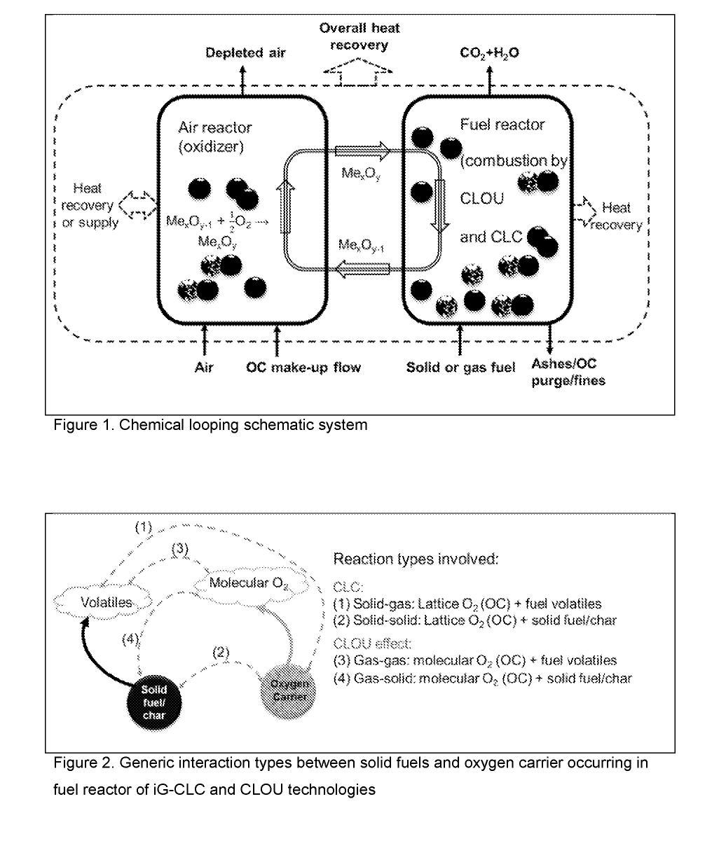

The following embodiments provide the preferred preparation methods to obtain the sustainable and efficient OCs herein presented, by scalable methods for industrial implementation.

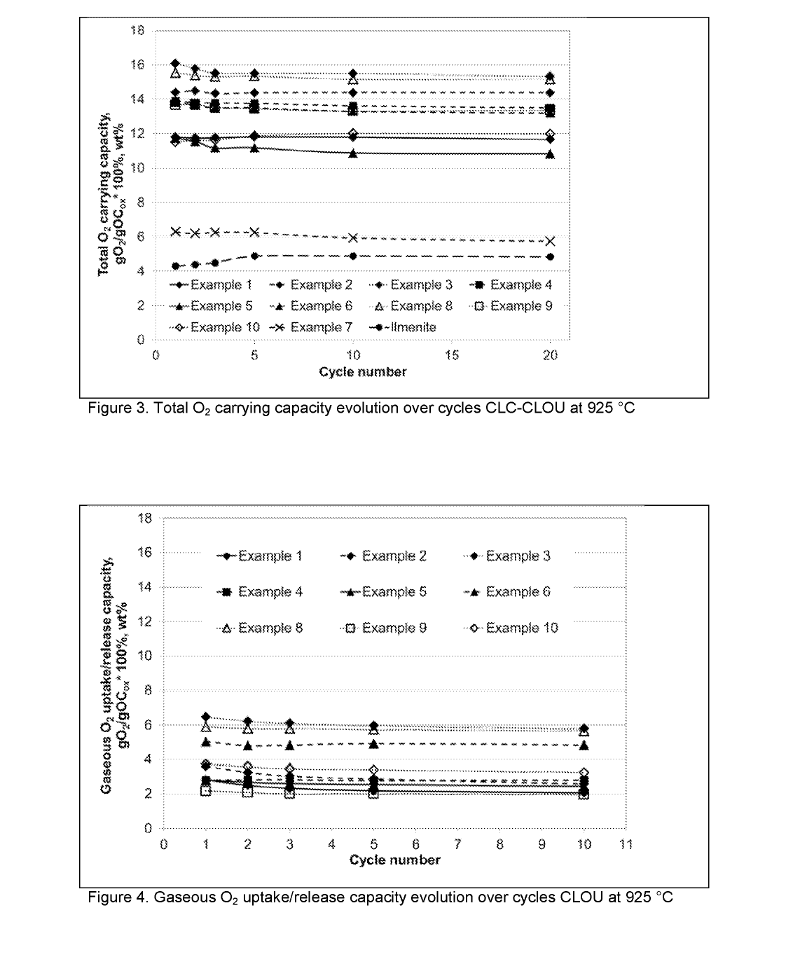

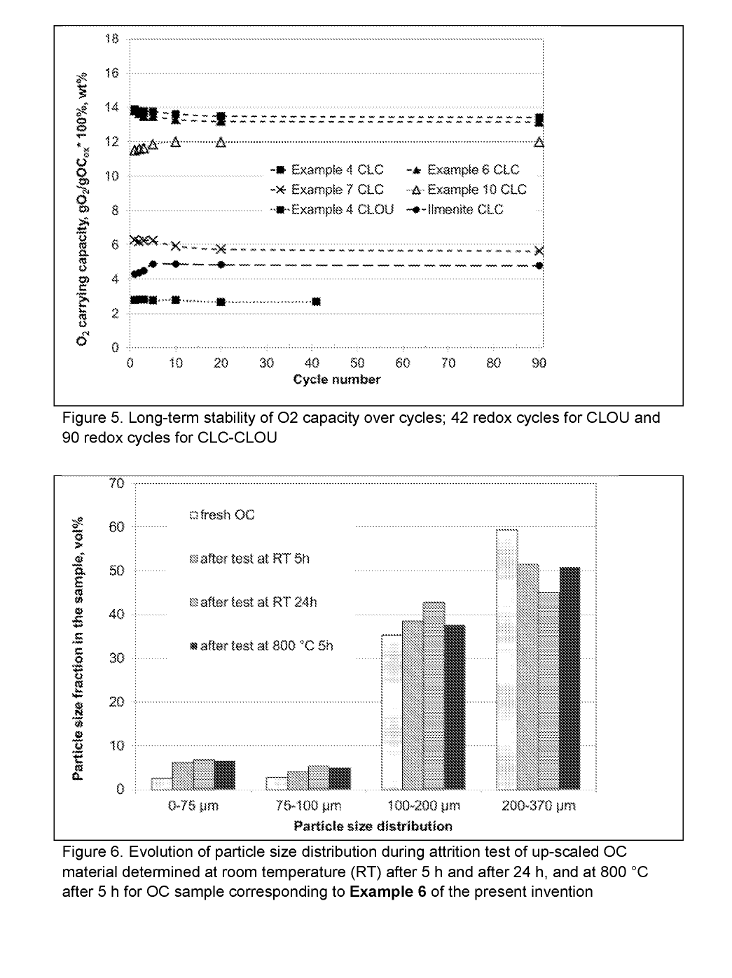

In one of the embodiments, the OC is prepared by an agglomeration method, where the active support is enriched with Cu, Mn, Co oxides or mixtures thereof by mechanical mixing. In the agglomeration method, the mixture of solids in powder form (support and the adequate quantity of Cu, Mn, Co oxides or mixtures thereof). If necessary, the materials can be pre-dried to eliminate excess moisture that might hinder the agglomeration effect. The mixture is introduced in the agglomerator vessel, and dry-mixed using the rotation shafts. In this method, a binder can be used to enhance the agglomerates production yield and mechanical strength. As an example, polyethylene glycol (PEG) or polyvinyl alcohol (PVA) in an aqueous solution can be used as binder. After dry-mixing, the binder (e.g. water or an aqueous solution of PEG) is slowly added to the mixture at controlled flow. If necessary, the binder addition process can be stopped and resumed several times in order to optimize the final agglomerates size and mechanical properties. Once powder mixture is agglomerated, the agglomerates can be dried in air at ambient temperature, and then at a higher temperature (e.g. between 50 and 120° C.) to remove the humidity. Finally, they agglomerates are calcined. As a result, round-shaped agglomerates are obtained with this method. The OC thereby produced shows higher oxygen carrying capacity per total mass than the capacity ever reported for OCs with the same amount of added Cu, Mn, Co oxides or mixtures thereof over inert supports, as shown in FIG. 3, FIG. 5, and Table 1 and Table 3, as well as high and stable CLOU performance as shown in FIG. 4, FIG. 5 and Table 3.

In addition, the resulting OC shows high mechanical strength, with high crushing strength values, as shown in Table 2 and Table 3.

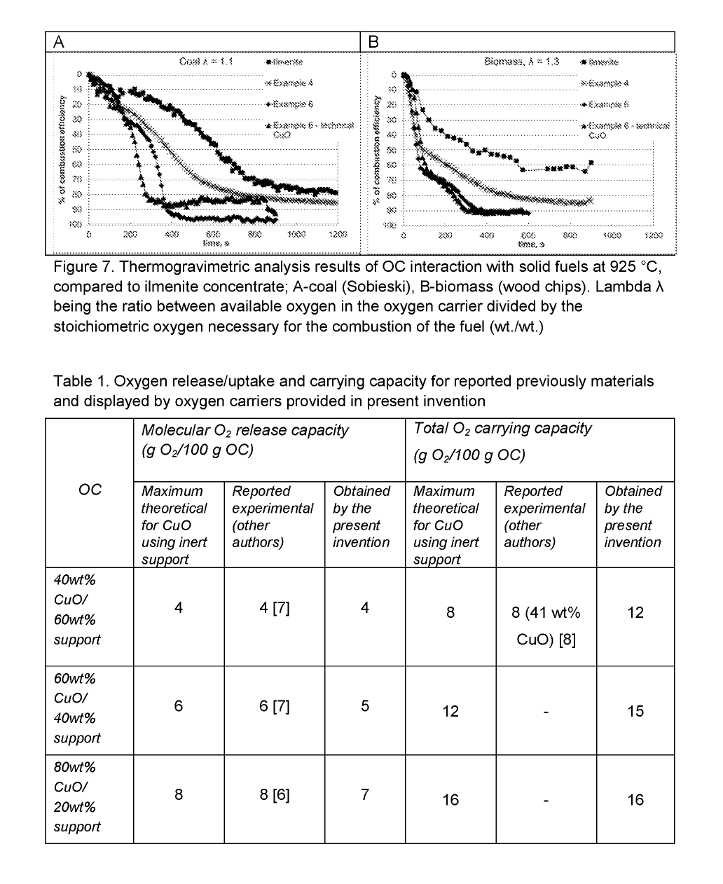

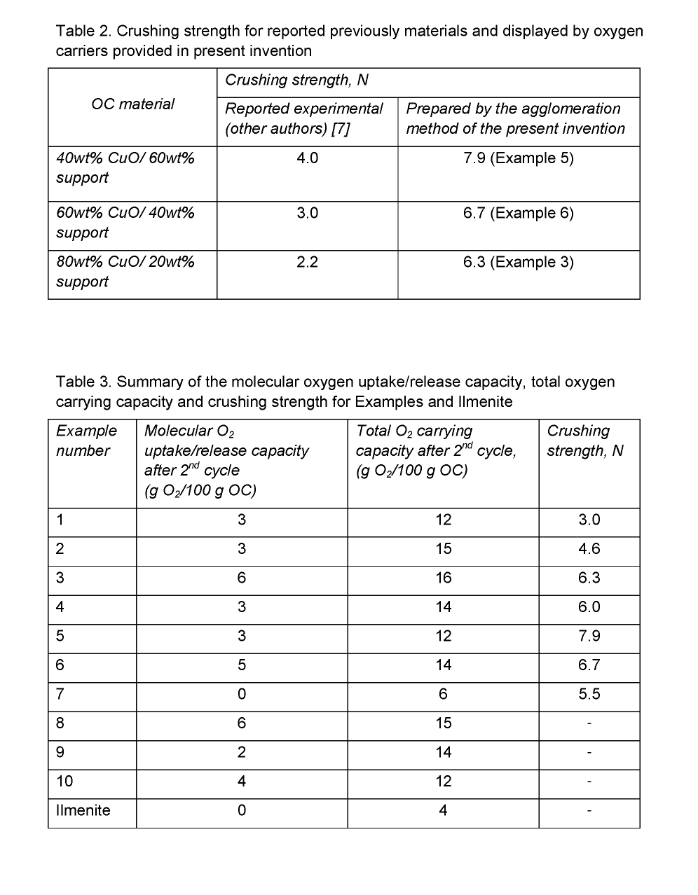

Furthermore, the preparation of OC according to this method can be scaled up for larger batches, with high oxygen capacity and good mechanical properties, as shown in FIG. 6 and FIG. 7.

In a preferred embodiment, the present invention provides an oxygen carrier prepared by the agglomeration method herein presented, wherein said oxygen carrier consists of agglomerates or particles wherein at least 80% of said particles have a size higher than 50 μm. In a more preferred embodiment, the present invention provides an oxygen carrier, hereby said oxygen carrier consists of agglomerates or particles wherein at least 80% of said particles have a size higher than 100 μm.

In another embodiment, the OC is prepared by a precipitation-coating method of Cu, Mn, Co oxides or mixtures thereof. The precipitation-coating method is based on the formation of CuO precipitate over the surface of support particles. In this method, a weighted amount of dried support is added to a certain volume of water and mixed to make a suspension. Weighted amount of Cu, Mn, Co oxides or mixtures thereof precursor salt (e.g. copper nitrate) is dissolved in another aliquot of water. The solution of the metal of metals salt is added dropwise to the suspension of support under continuous, vigorous stirring. A precipitation agent (e.g. NaOH aqueous solution) is added dropwise to the mixture with vigorous, continuous stirring, to modify the pH (e.g. until pH<10 in case of using copper nitrate as CuO precursor). The change of pH promotes the precipitation of the Cu, Mn, Co oxides or mixtures thereof over the particles of support present in the solution. After a certain time (e.g. 1-3 h of aging), the precipitate is filtered under vacuum, and washed several times with water until pH 7 and dried at a minimum of 50° C. for a minimum of one hour. The resulting material is calcined at a minimum of 500° C. The OC can be sieved down to the desired particle size distribution. Alternatively, the OC can be agglomerated, before or after calcination, according to the previous embodiment (i.e. the agglomeration method above described or similar). In another embodiment the particle size of the support is selected or modified accordingly to obtain higher or lower particle size of the final product.

In a preferred embodiment, the present invention provides an oxygen carrier prepared by the precipitation-coating method herein presented, wherein said oxygen carrier consists of agglomerates or particles wherein at least 80% of said particles have a size higher than 50 μm. In a more preferred embodiment, the present invention provides an oxygen carrier; hereby said oxygen carrier consists of agglomerates or particles wherein at least 80% of said particles have a size higher than 100 μm. As an example, several embodiments of the present invention are further demonstrated and described in the following proof of principle.

### Proof of Principle

All the materials and synthesis methods have been tested at laboratory scale, showing the technical feasibility of producing oxygen carriers with exceptional oxygen capacity and mechanical strength as above described.

Embodiments of the oxygen carriers herein disclosed are further demonstrated and described in the following description. The following examples and drawings will serve only to illustrate the technical viability of this invention and provide a useful description of the principles and conceptual aspects of this invention based on examples listed below, not limiting the invention to these particular embodiments.

### EXAMPLES

Oxygen carrier particles with high mechanical strength and oxygen carrying capacity for laboratory scale were prepared using 2 different syntheses and processing methods; 1) agglomeration in a high shear mixer/granulator for powder granulation and fines hydration/pelletization (GMX) and 2) direct CuO precipitation-coating over support and the processing of the resulting fines by hydration/pelletization.

Both methods involve the use of low cost industrial materials as active support i.e. materials from industry that contain certain amounts of metal oxides readily active in CLOU or CLC chemical reactions, as, for example oxides of Mn, Cu, Fe, Ni and/or Co. The low value industrial material as received from the industrial process was crushed and sieved adequately to the needs of each test.

Thermogravimetric analyses (TGA) of all the samples were carried out to determine the reactivity of the OCs along redox cycles under different atmospheres. Two main properties were determined: 1. Oxygen uptake/release capacity, where molecular oxygen is released from the OC lattice only by the effect of temperature, so-called CLOU effect; and 2. Total oxygen carrying capacity, so called CLC-CLOU behavior, where the oxygen carrier is reacting with the gases from solid fuel pyrolysis and gasification (CLC), and, at the same time, molecular oxygen is also released by the CLOU effect, as schematically shown in FIG. 2.

Initially, the samples were tested under argon atmosphere for reduction and with synthetic air for the oxidation step along redox cycles at 925° C. Their oxygen uptake/release capacity was determined from the weight variation measured in the TGA. These measurements were carried out using a thermogravimetric analyzer Netzsch STA 449 F3 Jupiter TG-DSC. The total flow was 200 cm³/min both for reduction and oxidation. The time of a complete redox cycle was 20 min. Typically 20 mg of sample were placed in the Al₂O₃ crucible. The measurements were baseline corrected by the Proteus software package. Evolution of O₂ uptake/release capacity over cycles CLOU is illustrated in FIG. 4. Later on, OCs were analyzed under mixtures of H₂ (5 vol. %), CH₄ (15 vol. %), H₂O (35 vol. %), CO₂ (25 vol. %), and N₂ (20 vol. %) for the reduction step and synthetic air, for the oxidation step, flushed with 100 vol. % N₂ in between with total flow 500 cm³/min and temperature 925° C. at all time. With this atmosphere, the gas composition expected around the particles in the fuel reactor of a CLC-CLOU system could be emulated and, therefore, it was determined the total oxygen carrying capacity of the OCs thereby tested. The evolution of total O₂ carrying capacity over CLC-CLOU cycles is illustrated in FIG. 3. Long-term stability of O₂ capacity over 42 redox cycles for CLOU and 90 redox cycles for CLC-CLOU was determined, as illustrated in FIG. 5.

The force needed to fracture a particle (i.e. crushing strength) was determined using a Digital Force Gauge SHIMPO FGV-10X apparatus. The mechanical strength was taken as the average value of at least 75 measurements undertaken on different particles of each sample randomly chosen.

Attrition resistance of up-scaled materials was determined using a test rig designed to simulate conditions in Chemical Looping Combustion reactor. 15 g of each sample was placed in a downcomer through the cyclone, the stand was mounted and compressed air was turned on with flow of 2.54 m³/h. This stream ensures that air speed reaches 100 m/s when going through contraction.

Macro-TGA experiments with solid fuels were carried out in isothermal conditions. Volumetric flow of 100% CO₂ was 0.040 m³/h. Sample was placed in the reactor when gas temperature inside the reactor reached 925° C. and kept inside until the mass stabilization—when no mass change was observed. The excess of oxygen available in the OC divided by the minimum or stoichiometric oxygen needed for the full combustion of the fuel for complete combustion (λ) is 1.1 for coal and 1.3 for biomass.

The results of tests with solid fuel and attrition tests are shown in FIG. 6 which illustrates attrition resistance of up-scaled OC corresponding to Example 6. The attrition was determined at room temperature after 5 h and 24 h, and at 800° C. after 5 h. FIG. 7 illustrates interaction of OC with solid fuel at 925° C.; A-coal, B-biomass (wood chips) concern samples corresponding to Example 4 and 6 prepared in large quantities of 0.5 to 2 kg compared with Ilmenite concentrate (example of secondary OC of this invention).

The OC materials presented by examples in this invention showed crushing strength at least equal to 3 N. The OCs with highest crushing strength were Examples 5, 6 and 3, with values corresponding to 7.9, 6.7 and 6.3 N, as shown in Table 3.

The CLOU capacity after the 2^{nd} redox cycle varied from 3 to 6 g O₂/100 g OC for agglomerated samples enriched with CuO (Examples 1-6), and from 2 to 6 g O₂/100 g for precipitated samples enriched with CuO (Examples 8-10), as shown in FIG. 4 and Table 3. Moreover, for the same examples, the CLC-CLOU capacity after 2^{nd} redox cycle varied from 12 to 16 g O₂/100 g OC and from 12 to 15 g O₂/100 g correspondingly, as shown in FIG. 3 and Table 3. Thus, OCs proposed by the present invention and obtained by different preparation methods showed similar high activity towards both CLC and CLC-CLOU applications.

All the Examples corresponding to OCs enriched with CuO performed better in terms of CLC-CLOU behavior than any OC reported in literature, as shown in Table 1. OC enriched with Mn oxide presented at Example 7, also showed very promising results of high and long term CLC-CLOU activity, as shown in Table 3, FIG. 3 and FIG. 5.

Moreover, the attrition test results for up-scaled sample corresponding to Example 6, shown in FIG. 6, indicate high attrition resistance of this OC both at room temperature overtime as well as elevated temperature. This result is in agreement with the high crushing strength values of this OC.

Macro-TGA experiments with solid fuels were also performed for up scaled samples corresponding to Examples 4 and 6, and were compared with ilmenite concentrate sample. As it is shown in FIG. 7, all the enriched OCs prepared according to the present invention show better reactivity than ilmenite concentrate (an example of secondary OC of the present invention), both for coal and biomass combustion.

### Examples Based on Mechanical Agglomeration Method:

In the agglomeration method, polyethylene glycol (PEG) aqueous suspension was used as an organic binder. The mixture of solids in powder form was dried at 100° C. for at least 2 h before the agglomeration tests. 100-200 g of powder was introduced in the 1 dm³ vessel of the agglomerator, and dry-mixed using rotation speed of 1500 rpm (mixer) and 3600 rpm (chopper). After 1 min of mixing, water or an aqueous solution of PEG was slowly added to the mixture using an integrated pump. After adding each 1 cm³ of solution, the binder addition was stopped and the vessel content was mixed for one extra minute with no dosing of liquid. Torque value was observed at all time of agglomeration. When a rapid increase of torque was detected, the agglomerator was stopped, and the total liquid volume used calculated. Round-shape agglomerates with sizes between 0.1 to 2 mm were obtained in the tests. Agglomerates were dried in air at ambient temperature and then overnight at 90° C. Finally, they were calcined. With this method, the obtained particles can be sieved to obtain the fraction of interest. In that case, smaller and bigger fractions can be separated, crashed if needed and reintroduced in the agglomeration unit for further processing. The measured oxygen carrying capacity on pure CLOU and on CLC-CLOU effects, and the crushing strength values are shown in Table 3.

### Example 1

A preparation of an oxygen carrier involves agglomeration of 48 g of CuO, 72 g of Mn sinter (with an approximate content of 60 wt. % of Mn in oxide form) using 13.2 g of 15 wt. % aqueous solution of polyethylene glycol 4000. Dried agglomerates are calcined for 2 h at 820° C. using a Heraeus-Saga Petroleum furnace with static air flow and the following temperature profile: starting temperature 90° C., heating at 10° C./min up to 820° C. during 2 hours, then cooling down to 90° C. at 15° C./min, thereby obtaining 40 wt. % of CuO (primary OC) and 60 wt. % of Mn sinter (secondary OC) agglomerates as final product.

### Example 2

A preparation of an oxygen carrier according to the experimental conditions described in Example 1, wherein the quantities of CuO, manganese sinter and the binder are as follows: 60 g of CuO, 40 g of Mn sinter using 11.8 g of 15 wt. % aqueous solution of polyethylene glycol 4000. Thereby obtaining 60 wt. % of CuO (primary OC) and 40 wt. % of Mn sinter (secondary OC) agglomerates as final product.

### Example 3

A preparation of an oxygen carrier according to the experimental conditions described in Example 1 wherein the quantities of CuO, manganese sinter and the binder are as follows: 80 g of CuO, 20 g of Mn sinter using 12.6 g of 15 wt. % aqueous solution of polyethylene glycol 4000. Thereby obtaining 80 wt. % of CuO (primary OC) and 20 wt. % of Mn sinter (secondary OC) agglomerates as final product.

### Example 4

A preparation of an oxygen carrier involves agglomeration 90 g of CuO, 30 g of ilmenite concentrate (with an approximate content of 35 wt. % of Fe in oxide form) and 30 g of fly-ash (from Sobieski coal) using 22 g of 15 wt. % aqueous solution of polyethylenglycol 4000. Dried agglomerates are calcined for 2 h at 1100° C. using a Heraeus-Saga Petroleum furnace with static air flow and the following temperature profile: starting temperature 90° C., heating at 10° C./min up to 1100° C. during 2 hours, then cooling down to 90° C. at 15° C./min, thereby obtaining 60 wt. % of CuO (primary OC), 20 wt. % of Ilmenite (secondary OC) and 20 wt. % of fly-ash (binder) agglomerates as a final product.

### Example 5

A preparation of an oxygen carrier involves agglomeration 32 g of CuO, 48 g of Mn-containing tailing (with a content lower than 60 wt. % Mn in oxide state) using 9.4 g of 15 wt. % aqueous solution of polyethylene glycol. Dried agglomerates are calcined for 2 h at 820° C. using a Heraeus-Saga Petroleum furnace with static air flow and the following temperature profile: starting temperature 90° C., heating at 10° C./min up to 820° C. during 2 hours, then cooling down to 90° C. at 15° C./min, thereby obtaining 40 wt. % of CuO (primary OC) and 60 wt. % of Mn-containing tailing (secondary OC) agglomerates as final product.

### Example 6

A preparation of an oxygen carrier according to the experimental conditions described in Example 5, wherein the quantities of CuO, Mn-containing tailing and the binder are as follows: 90 g of CuO, 60 g of Mn-containing tailing using 17.1 g of 15 wt. % aqueous solution of polyethylene glycol 4000. Thereby obtaining 60 wt. % of CuO (primary OC) and 40 wt. % of Mn-containing tailing (secondary OC) agglomerates as final product.

### Example 7

A preparation of an oxygen carrier involves agglomeration 60 g of MnO₂, 40 g of Mn-containing tailing (with a content lower than 60 wt. % Mn in oxide state) using 21 g of 15 wt. % aqueous solution of polyethylene glycol. Dried agglomerates are calcined for 2 h at 820° C. using a Heraeus-Saga Petroleum furnace with static air flow and the following temperature profile: starting temperature 90° C., heating at 10° C./min up to 820° C. during 2 hours, then cooling down to 90° C. at 15° C./min, thereby obtaining 60 wt. % of Mn₂O₃ (primary OC) and 40 wt. % of Mn-containing tailing (secondary OC) agglomerates as final product.

### Examples Based on Precipitation-Coating Method

The precipitation-coating method is based on the generation of CuO precipitate over the surface of active support particles. A weighted amount of dried support (particle size <100 μm) is added to deionized water and mixed to make a suspension using magnetic stirrer (600 rpm, RT, 10 min). Weighted amount of copper precursor salt is dissolved in deionized water and mixed (800 rpm, RT, 10 min). Solution of copper salt is added dropwise to the aqueous suspension of support (15-20 drops/min) under continuous, vigorous mechanical stirring. Precipitation agent is a 2 mol/dm³ NaOH aqueous solution. It is added dropwise to the precursor and support mixture until pH value is equal to 10 (15-20 drops/min), with vigorous, continuous stirring. After 1-3 h of aging, precipitate is filtered under vacuum, washed several times with water to pH value 7 and dried at 90° C. overnight. The material is calcined at temperatures varying between 820 and 1100° C. Agglomeration of precipitate can be another step before or after calcination. Several embodiments of the invention were prepared and are reported below.

### Example 8

A preparation of an oxygen carrier by the CuO precipitation-coating method involves suspending 8 g of Mn-containing tailing (with a content lower than 60 wt. % Mn in oxide state) in 75 cm³ of deionized water. At the same time, 36.24 g of copper (II) nitrate trihydrate Cu(NO₃)₂.3H₂O is dissolved in deionized water. Solution of copper salt (2 mol/dm³) is dropped to a suspension of support (15-20 drops/min) under continuous, vigorous mechanical stirring. NaOH aqueous solution is dropped to the mixture of precursor and support until pH value >10 (15-20 drops/min), with vigorous, continuous stirring. After 2 h of aging, precipitate is filtered under vacuum, washed 4 times with deionized water to pH value 7 and dried at 90° C. overnight. Dry precipitate is calcined for 2 h at 820° C. using a Heraeus-Saga Petroleum furnace with static air flow and the following temperature profile: starting temperature 90° C., heating at 10° C./min up to 820° C. during 2 hours, then cooling down to 90° C. at 15° C./min, thereby obtaining 60 wt. % of CuO (primary OC) and 40 wt. % of Mn-containing tailing (secondary OC) powder as final product.

### Example 9

A preparation of an oxygen carrier by the CuO precipitation-coating method involves suspending 8 g of ilmenite concentrate (with an approximate content of 35 wt. % of Fe in oxide form) in 75 cm³ of deionized water. Afterwards, preparation of the oxygen carrier is performed according to the experimental conditions described in Example 8. Washed and dry precipitate is calcined for 2 h at 1100° C. using a Heraeus-Saga Petroleum furnace with static air flow and the following temperature profile: starting temperature 90° C., heating at 10° C./min up to 1100° C. during 2 hours, then cooling down to 90° C. at 15° C./min, thereby obtaining 60 wt. % of CuO (primary OC) and 40 wt. % of ilmenite concentrate (secondary OC) powder as final product.

### Example 10

A preparation of an oxygen carrier by the CuO precipitation-coating method involves suspending 8 g of Mn sinter (with an approximate content of 60 wt % of Mn in oxide form) in 75 cm³ of deionized water. Afterwards, preparation of the oxygen carrier is performed according to the experimental conditions described in Example 8, thereby obtaining 60 wt. % of CuO (primary OC) and 40 wt. % of Mn sinter (secondary OC) powder as final product.

In summary, OCs prepared by this invention have shown significantly higher O₂ carrying capacity for CLC-CLOU than the maximum theoretical capacity ever reached by OCs stabilized with synthetic non-active supports. Table 1 compares the molecular oxygen release capacity and total oxygen carrying capacity for OCs containing different amount of CuO as an active phase for reported values and provided in the present invention. Ilmenite concentrate was selected as an example of the secondary OC of the present invention for comparison. Results of the total oxygen carrying capacity of ilmenite concentrate are presented in FIG. 3, FIG. 5 and Table 3.

Results of the molecular oxygen release capacity, total oxygen carrying capacity and crushing strength for Examples of this invention and an example of the secondary OC (ilmenite concentrate) are summarized in Table 3. It is preferred that the oxygen carrier has a minimum oxygen carrying capacity higher than 6 g O₂/100 g OC, and more preferred higher than 12 g O₂/100 g OC, this later value being achieved in Examples 1-6 and 8-10, cf. table 3.

Another advantage of preparing OCs by the present invention is the high mechanical strength of the resulting materials, compared to previously reported OCs which combine CuO with synthetic supports in different compositions, as shown in Table 2. The last but not less important advantage of OCs provided by this invention comparing to known materials is their potential for producing cost-effective OCs, based on low-value industrial streams and by using simple and scalable production methods.

### REFERENCES

1. Lewis, W. K., Gilliland, E. R., and Sweeney, M. P., Gasification of carbon: metal oxides in a fluidized powder bed. Chemical Engineering Progress, 1951. 47: p. 251-256.
2. Mattisson, T., Lyngfelt, A., and Leion, H., Chemical-looping with oxygen uncoupling for combustion of solid fuels. International Journal of Greenhouse Gas Control, 2009. 3(1): p. 11-19.
3. Mattisson, T., Materials for Chemical-Looping with Oxygen Uncoupling. ISRN Chemical Engineering, 2013.
4. Azimi, G., Leion, H., Mattisson, T., and Lyngfelt, A., Chemical-looping with oxygen uncoupling using combined Mn-Fe oxides, testing in batch fluidized bed. Energy Procedia, 2011. 4(0): p. 370-377.
5. Imtiaz, Q., Hosseini, D., and Müller, C. R., Review of Oxygen Carriers for Chemical Looping with Oxygen Uncoupling (CLOU): Thermodynamics, Material Development, and Synthesis. Energy Technology, 2013. 1(11): p. 633-647.
6. Imtiaz, Q., Broda, M., and Müller, C. R., Structure-property relationship of co-precipitated Cu-rich, Al2O3- or MgAl2O4-stabilized oxygen carriers for chemical looping with oxygen uncoupling (CLOU). Applied Energy, 2014. 119(0): p. 557-565.
7. Gayán, P., Adánez-Rubio, I., Abad, A., de Diego, L. F., Garcia-Labiano, F., and Adánez, J., Development of Cu-based oxygen carriers for Chemical-Looping with Oxygen Uncoupling (CLOU) process. Fuel, 2012. 96(0): p. 226-238.
8. Hossain, M. M. and de Lasa, H. I., Chemical-looping combustion (CLC) for inherent separations—a review. Chemical Engineering Science, 2008. 63(18): p. 4433-4451.
9. Linderholm, C., Lyngfelt, A., Cuadrat, A., and Jerndal, E., Chemical-looping combustion of solid fuels—Operation in a 10 kW unit with two fuels, above-bed and in-bed fuel feed and two oxygen carriers, manganese ore and ilmenite. Fuel, 2012. 102(0): p. 808-822.
10. Arjmand, M., Leion, H., Mattisson, T., and Lyngfelt, A., Investigation of different manganese ores as oxygen carriers in chemical-looping combustion (CLC) for solid fuels. Applied Energy, 2014. 113(0): p. 1883-1894.

1-14. (canceled)

15. An oxygen carrier for use in chemical looping technology with oxygen uncoupling (CLOU) for the combustion of a carbonaceous fuel, comprising:
a primary oxygen carrier component comprising a commercial grade metal oxide selected from the group consisting of Cu, Mn, and Co oxides and mixtures thereof; and
a secondary oxygen carrier component comprising an industrial material which contain a metal oxide selected from the group consisting of Cu, Mn, Co, Fe and Ni oxides and mixtures thereof, wherein
the secondary oxygen carrier component has an oxygen carrying capacity of no less than 1.0 g of O₂/100 g material in chemical looping reactions.

16. The oxygen carrier according to claim 15, wherein said secondary oxygen carrier component is mixed with an amount of fuel ashes from fuel combustion, thereby facilitating production and enhancing mechanical stability of the oxygen carrier.

17. The oxygen carrier according to claim 15, wherein the carbonaceous fuel is selected from the group consisting of solid, liquid and gaseous carbonaceous fuels and mixtures thereof.

18. The oxygen carrier according to claim 15, wherein the carbonaceous fuel is predominantly solid fuels.

19. The oxygen carrier according to claim 15, wherein the primary oxygen carrier component is present in a concentration within the range of approximately 15-99% by weight.

20. The oxygen carrier according to claim 15, wherein the primary oxygen carrier component predominantly comprises oxides of Cu.

21. The oxygen carrier according to claim 15, wherein said secondary oxygen carrier component comprises waste material or a process-stream material generated from the production of ilmenite and comprises oxides selected from the group consisting of Fe, Mn, Cu, Co and Ni and mixtures thereof.

22. The oxygen carrier according to claim 15, wherein said secondary oxygen carrier component comprises waste material or a process-stream material from production of manganese-bearing materials and comprises oxides selected from the group consisting of Mn, Fe, Cu, Co and Ni and mixtures thereof.

23. The oxygen carrier according to claim 15, wherein said secondary oxygen carrier component comprises waste material or a process-stream material from production of cobalt-bearing materials and comprises oxides selected from the group consisting of Co, Mn, Fe, Cu and Ni and mixtures thereof.

24. The oxygen carrier according to claim 15, wherein said secondary oxygen carrier component comprises waste material or a process-stream material from production of nickel-bearing materials and comprises oxides selected from the group consisting of Ni, Co, Mn, Fe and Cu and mixtures thereof.

25. The oxygen carrier according to claim 15, wherein the oxygen carrier has an oxygen carrying capacity of no less than 1.2 g O₂/100 g.

26. The oxygen carrier according to claim 15, wherein the oxygen carrier takes the form of particles prepared by agglomeration, compaction, palletization or spray drying and has a measured crushing strength of at least 3 N.

27. The oxygen carrier according to claim 15, wherein the primary oxygen carrier component is present in a concentration within the range of approximately 40-90% by weight.

28. The oxygen carrier according to claim 15, wherein the primary oxygen carrier component is present in a concentration within the range of approximately 60-80% by weight.

29. The oxygen carrier according to claim 15, wherein the oxygen carrier takes the form of particles prepared by agglomeration, compaction, palletization or spray drying and has a measured crushing strength of at least 5 N.

30. The oxygen carrier according to claim 15, wherein the oxygen carrier takes the form of particles prepared by agglomeration, compaction, palletization or spray drying and has a measured crushing strength of at least 7 N.

31. The oxygen carrier according to claim 15, wherein the oxygen carrier has an oxygen carrying capacity of no less than 6 g O₂/100 g.

32. The oxygen carrier according to claim 15, wherein the oxygen carrier has an oxygen carrying capacity of no less than 12 g O₂/100 g.

33. A method of manufacturing an oxygen carrier for use in chemical looping technology with oxygen uncoupling (CLOU) for the combustion of carbonaceous fuel comprising a primary oxygen carrier component comprising a commercial grade metal oxide selected from the group consisting of Cu, Mn, and Co oxides and mixtures thereof, and a secondary oxygen carrier component comprising an industrial material which contain a metal oxide selected from the group consisting of Cu, Mn, Co, Fe and Ni oxides and mixtures thereof, wherein the secondary oxygen carrier component has an oxygen carrying capacity of no less than 1.0 g of O₂/100 g material in chemical looping reactions, comprising the steps of:
a. providing commercial grade metal oxides selected from the group consisting of Cu, Mn, and Co oxides and mixtures thereof as the primary oxygen carrier component;
b. providing metal oxides selected from the group consisting of oxides of Cu, Mn, Fe, Co, and Ni from an industrial waste, tailing process stream or by-product as the secondary oxygen carrier component;
c. mixing and subjecting the primary oxygen carrier component and secondary oxygen carrier component to conditions under which granule-forming agglomeration occurs to form granule; and
d. thermally treating the granules by a process selected from the group consisting of cooling, drying and calcination and combinations thereof.

34. A method of manufacturing an oxygen carrier for use in chemical looping technology with oxygen uncoupling (CLOU) for the combustion of carbonaceous fuel comprising a primary oxygen carrier component comprising a commercial grade metal oxide selected from the group consisting of Cu, Mn, and Co oxides and mixtures thereof, and a secondary oxygen carrier component comprising an industrial material which contain a metal oxide selected from the group consisting of Cu, Mn, Co, Fe and Ni oxides and mixtures thereof, wherein the secondary oxygen carrier component has an oxygen carrying capacity of no less than 1.0 g of O₂/100 g material in chemical looping reactions, comprising the steps of:
a. providing commercial grade metal oxides selected from the group consisting of Cu, Mn, and Co oxides and mixtures thereof as the primary oxygen carrier component;
b. providing metal oxides selected from the group consisting of oxides of Cu, Mn, Fe, Co, and Ni from an industrial waste, tailing process stream or by-product as the secondary oxygen carrier component;
c. mixing the primary oxygen carrier component and secondary oxygen carrier component in a solution and subjecting the solution to conditions under which granule precipitation of added Cu, Mn, Co or mixtures thereof occurs,
d. thermally treating the granules by a process selected from the group consisting of cooling, drying and calcination and combinations thereof.
